(19) United States
(12) Patent Application Publication
(10) Pub. No.: US 2003/0192027 A1
(43) Pub. Date: Oct. 9, 2003

(54) Software application development

(76) Inventor: Mathew Deon Porter, Victoria (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/380,010

(22) PCT Filed: Sep. 10, 2001
(86) PCT No.: PCT/AU01/01135

(51) Int. Cl. G06F 9/44

(52) U.S. Cl. 717/100

(57) ABSTRACT

The invention concept resides in a recognition that application development environments are advantageously improved by using an interface and accompanying software components that provide a predefined n-tier application architecture preferably involving the use of a folder and item-based metaphor to group application components for subsequent manipulation and execution. Execution of application components may be in any nominated sequence, or in parallel using multithreading or related approaches. This approach affords the visual representation of abstract software development concepts using a familiar folder/item paradigm, as well as removing the necessity of custom-building application infrastructure and implementing recommended design patterns and techniques, since embodiments of the invention implement these concepts. Accordingly, the invention provides a method of providing an application development environment for developing software applications, in which a plurality of components provided in the environment can be arranged in a hierarchy to facilitate execution of some or all of said abstract components. The invention also provides the environment referred to above. The environment is capable of being used through a graphical users interface which complements the hierarchical structure. The invention also extends to a computer or network of computers that implements or implement the environment.

### FIELD OF THE INVENTION

The invention relates to software application development and relates particularly, though not exclusively, to application development environments suitable for rapid application development of software applications.

### BACKGROUND OF THE INVENTION

Due to the increasing complexity of computer applications, application development environments have been provided to assist developers in producing sophisticated and reliable applications in shorter time frames.

Conventionally, software applications were compiled from source code which might have been prepared using a text editor. Later, so-called integrated development environments were developed, being applications that helped the developer produce source language for subsequent compilation into object code and linking into a complete application. Later application development tools involved the provision of a visual interface. For example, Microsoft Visual Basic allows applications to be developed visually with a Graphical User Interface by specifying properties in a dialog box for a number of inter-related components.

Each of the application development environments referred to above has generally represented a refinement on the previous system and has proved to be of benefit in some development contexts. However, the process of application development, despite the increasing use and reuse of existing components, is still often a laborious and time-consuming process. As a result, improvements to conventional approaches can be improved to address existing problems of application development time which depends on the complexity required to produce applications, particularly in larger and more complex developments. None of these improvements however have approached the aforementioned problems using a folder/item metaphor such that this represents a collection of software components that interact and/or execute in sequence or parallel.

It is an object of the invention to at least attempt to address these and other deficiencies of the existing prior art or to at least provide the public with a useful choice.

Definition

Throughout this document, unless there is a clear and express indication to the contrary, reference to the term “software” is taken to include reference to other forms of programmable intelligence such as, or example, firmware or programmable hardware.

### SUMMARY OF THE INVENTION

The invention concept resides in a recognition that application development environments are advantageously improved by using an interface and accompanying software components that provide a predefined n-tier application architecture preferably involving the use of a folder and item-based metaphor to group application components for subsequent manipulation and execution. Execution of application components may be in any nominated sequence, or in parallel using multithreading or related approaches. This approach affords the visual representation of abstract software development concepts using a familiar folder/item paradigm, as well as removing the necessity of custom-building application infrastructure and implementing recommended design patterns and techniques, since embodiments of the invention implement these concepts.

Accordingly, the invention provides a method of providing an application development environment for developing software applications including the steps of providing a hierarchical structure visually represented as a folder/item metaphor for organisation of a plurality of software component items to be executed in the environment, providing each component item with one or more associated features and visually grouping the component items using the folder/item metaphor to allow features of one component item to apply to other component items in the environment.

The invention also provides the environment referred to above having a hierarchical structure visually represented as a folder/item metaphor for organisation of a plurality of software component items to be executed in the environment, each component item including one or more associated features and the component items being visually grouped using the folder/item metaphor to allow features of one component item to apply to other component items in the environment. The environment is capable of being used through a graphical users interface which complements the hierarchic structure. The invention also extends to a computer or network of computers that implements or implements the environment.

The invention further provides a graphical user interface for software application development, the interface providing a hierarchical structure visually represented as a folder/item metaphor for organisation of a plurality of software component items to be executed in the environment, each component item including one or more associated features and the component items being visually grouped using the folder/item metaphor to allow features of one component item to apply to other component items in the environment.

Preferably a run-time environment is also provided.

Preferably the environment allows simultaneous or sequential execution of the component items.

Preferably, the folder/item metaphor used for representing said hierarchy in said environment to a developer is a folder/item metaphor used in file systems, as well as for operating system artefacts in such operating systems as Microsoft Windows 2000™. This metaphor helps developers to become familiar with the development environment easily, and enables less-experienced software developers to quickly produce software that would normally require more skilled developers resources. In addition, skilled or relatively unskilled developers can re-use the supplied or custom developed software components to perform a wide variety of trivial and complex development tasks, ranging from database access and file system operation through to integration with custom hardware devices and the sending of SMS messages, whilst focussing their attention on satisfying the business rather than technical requirements of the project.

Preferably, said plurality of component items includes one or more:

(a) groupings of said component items; and

(b) application components.

Preferably, said plurality of component items further includes one or more references to component items, as either a reference to a grouping of component items or a reference to an application component.

Preferably, said environment uses said folder/item metaphor so that:

(a) a grouping of said component items is represented as a folder;

(b) an application component is represented as a component item; or

(c) a reference to an application component is represented as a shortcut to a component item, or an alias for a component item.

Preferably, the grouping of said component items represents the collection of the grouped component items, rather than the collective components per se. Accordingly, an instance of a grouping of said component item necessarily defines a parent component item and at least one child component item.

Preferably, a component item can have an associated condition object which determines whether the application component is to be executed. If the condition object returns an appropriate flag, the component item with which it is associated will or will not be executed, depending on the configuration of the condition.

Preferably, said environment further includes one or more data storage components and preferably said data storage components are represented in said environment by a catalog, or top level storage component in said folder/item metaphor. Preferably, each of said data storage components includes associated component items. Preferably, said data storage components include references to actual data objects.

Preferably, a single data storage component is instantiated for each application, or for a group of similar applications.

Preferably, said component items can be of a type different from those enumerated above. Preferably, all said component items, while being of different possible types, share a core set of object interface features.

Preferably, there are provided code templates to assist developers in creating application objects that are suitable for creating corresponding application components.

Preferably, said component items can have associated parameters and results, which can be passed between parent and child component items. Parameters represent data entering a component item, while results represent data returned by a component item.

Preferably, only said groups component items can be executed as a group by a client application. When a group of component items is executed, each of its child component items is executed. These child component items are likely to include a combination of other groups of component items, as well as application components and references to other application components. Ultimately, a sequence of application components is executed. Preferably, the order or sequence in which said application components are executed is determined dynamically by using configuration information provided by the environment.

Preferably, said application components are existing software components, modified as required to operate with said environment.

Preferably, application component identification codes and associated information is stored in a configuration object which is independent of each of said component items. Preferably, this configuration object is a suitably structured data file, or a conventional database object.

The described embodiment allows application objects to be combined in a dynamically defined sequence. This facilitates middle-tier execution and data retrieval and manipulation. XML capabilities are incorporated, as well as the ability to communicate with disparate data sources and systems including, for example, ODBC, LDAP, POP3, SMTP, SMS, and WAP. The described embodiment can interact with a wide variety of data sources or systems as it supports many varieties of data and object types. The described embodiment can be conveniently implemented as a “snap-in” within the Microsoft Management Console, which is a standard application that ships with the Microsoft Windows NT 4.0, Microsoft Windows 2000 and later operating systems.

The functionality of the described embodiment is focussed on the ability to bring together a variety of disparate data sources and elements, combining and manipulating them, and then delivering them to the end-user (or client application in the case of a system focussed process) in a suitable form.

The described embodiment has been implemented to take advantage of the Microsoft Visual environment, with appropriate modification where necessary, to function within the Microsoft Visual Studio tool set, but its use in not limited to that tool set. The described embodiment can also be an environment in which a similar tool set is available. An example is the Delphi/Interbase solution rather than the Visual Studio/SQL Server solution.

Desirably, the described embodiment is able to manage issues of scalability, reliability (for example, by appropriate data validation, error handling and reporting), and multithreading. Features such as these leave the developer free to concentrate on issues such as business logic and user interface development.

Other features of the described embodiment allow developers to increase their productivity by provision of design guides and templates.

Standard application components are desirably included in the environment provided by the described embodiment for commonly required functionality involving, for example, data access, security, auditing, or facilitating web development.

The invention further includes a software interface, and software instructions, for providing the described environment.

### DRAWING DESCRIPTION

One or more preferred embodiments of the invention will be described below with reference to the accompanying drawings of which:

FIG. 1 is a schematic of an application architecture according to the invention; and

FIG. 2 is an outline diagram of objects used in the preferred embodiment.

### DESCRIPTION OF EMBODIMENTS

The described embodiment provides an environment for application development which uses a folder/item metaphor to assist to developing software applications. The folder/item metaphor described herein refers to computing metaphors used generally to represent recursive structures in graphical user interface computing systems. This metaphor, which represents software components and other related features familiar to software developers, is used to assemble software components which conform with standards that facilitate their use in the described environment to allow for ease of assembly of software applications across multiple platforms.

Terminology

The environment adopts a terminology not generally familiar to software developers using existing tools. Accordingly, this terminology is now described with reference to conventionally-used terms with which those experienced in software development are familiar.

The environment provides for the use of a hierarchy of software components, similar to folders and files in a file system metaphor used in conventional computing environments. As with the folder/file metaphor, directories are represented as just another type of item.

A catalogue represents an abstract data source within the environment. The analogous feature in the folder/file metaphor is the disk drive letter in the MS-DOS environment. A catalog can have a number of dependent catalog items. These may be of different types. For the purposes of describing the environment, there are four different classes of catalogue item, namely, folders, shortcuts, string-tables and activities. It should be noted however that these represent a subset of the available items. Folders and shortcuts are named for their correspondingly-named entities in the folder/file metaphor.

Folders are common to most if not all folder/file metaphors, while shortcuts, in the folder/file metaphor, are references, shortcuts or aliases for other catalog items, most commonly folders or activities.

Activities represent software components of a specified abstract form able to be used in the environment for assembly of software applications, and correspond with files or documents in the folder/file metaphor.

General architecture

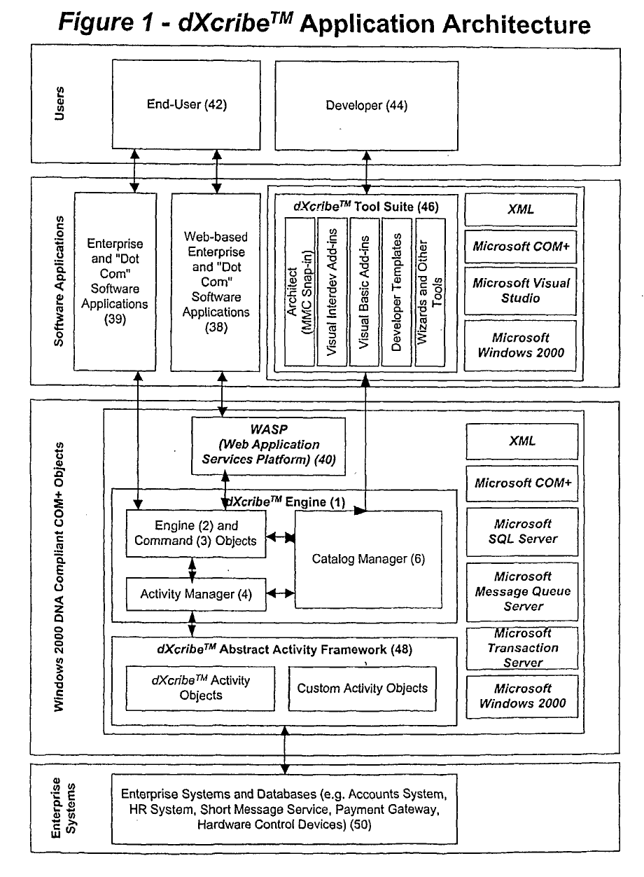

The general architecture is shown in FIG. 1.

The environment is built upon an environment engine 1 which is able to manage the execution of components in the environment. A practical embodiment of the invention will be marketed under the trademark dXcribe, and use of this mark refers to the environment of the present invention. The engine object 2 and command object 3 interact directly with an activity manager 4, which in turn communicates with a catalog manager 6 which stores configuration information as later described. The primary role of the activity manager, however, is to interact with various activity methods which are associated with corresponding underlying software components.

There is no limit to the nesting of folders within folders. At run time, applications point to a specific folder, and the environment will “run” that folder. The engine interprets different catalog item types in different ways.

As with a file system, folders can contain other folders or any other catalog item type. The only difference between folders and other catalog item types is the way that the engine interprets them.

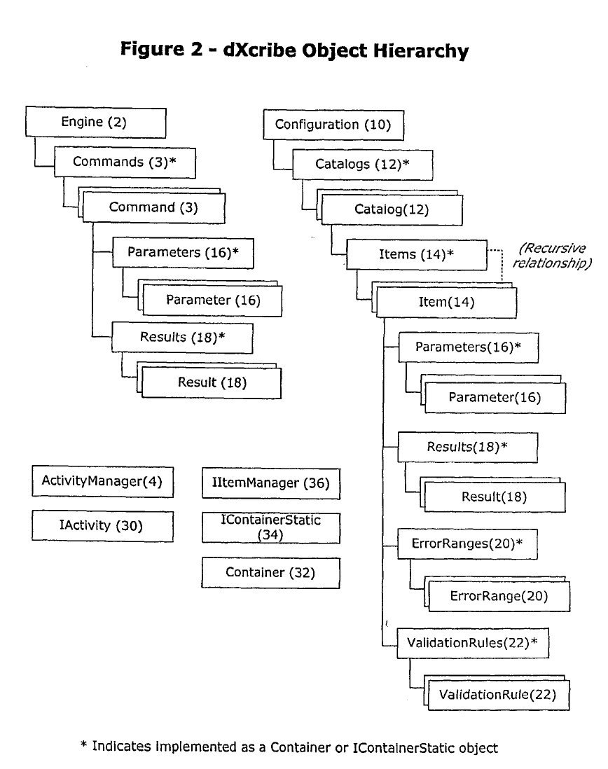

Referring to FIG. 2 the hierarchy of objects is illustrated. The configuration object is referenced 10, catalogs are referenced 12 and catalog items are referenced 14.

Catalog items 14 can have parameters 16 and results 18. This assists in accommodating the flow of data in and out of the engine. Parameters represent data coming into a catalog item, and results represent data provided by a catalog item. Error ranges 20 and validation rules 22 may also be added to catalog items to facilitate user-friendly error handling and validation.

Catalog items can also have conditions. Conditions are software code entities, that return a boolean value when called, to indicate whether the associated catalog item 14 should be executed. Typically, conditions are written in a scripting language such as VBScript or JScript code that returns a boolean value.

Catalogs and catalog items, and associated parameters, results and conditions are described in further detail below.

Catalogs

Catalogs are a pointer to the data storage for a configuration data. The configuration data is stored in a suitable repository, such as an XML file, or in an SQL Server database. The configuration for several similar applications can be stored in one catalog, or a catalog can be created for each new application to be developed.

A new catalog can be created in the environment architect by a similar operation for creating folders in the graphical computing systems. Once the requisite actions are performed, a blank property dialog page is created for the new catalog.

The various fields of the property dialog page are entered as required. These include: the name of the catalog that has been created, a description (optional), a storage type, and path (if an XML file is used as storage) or connection string (if a database is used instead). If the newly created catalog points to an existing XML file or database, the environment architect will simply connect to the existing data. Otherwise, default files are created automatically when the first catalog item is added to the new catalog. The properties of an existing catalog can be edited at any time after creation.

A catalog can be deleted at any time. It is preferred though that this action does not remove the file or database table(s) in which data is stored. This is a deliberate safety measure. Other mechanisms outside of the dXcribe Architect environment need to be used to delete the underlying data in the conventional manner.

Catalog items

As noted above, “catalog item” is the generic name for all configuration objects in the environment, including but not limited to folders, activities, string-tables and shortcuts. Most features (including parameters and results, error handlers, validation rules, or conditions) apply to catalog items, and this means that they can apply to all configuration objects in the environment. This is highly advantageous as it allows developers to leverage the uniformity of the environment to produce applications with greater ease.

Catalog items are created, edited and deleted in a similar manner as for catalogs. Each catalog item has a corresponding set of property fields which can be modified with the use of an associated property page. Other attributes relating to other aspects of the catalog items, such as appropriate security settings can also be accessed from the property page.

Folders

Folders are a grouping mechanism for items, as in the physical world. Folders can contain any number of any catalog items—folders, activities, string-tables or shortcuts. In addition, they can get parameters from an application or their parent folder or sibling catalog items and can return results.

Only folders can be executed by external applications (that is, the application which is being developed with the assistance of the environment). When a folder is executed, the environment engine executes all of it's child catalog items, providing them with data, and retrieving data from them. These child catalog items can also be executed based on conditions.

Activities

Activities are the primary elements of the environment, and represent executable components. Activities refer to software components or script code (for example, VBScript/JScript code). They receive parameters from their parent folder or sibling catalog items to use, and provide results to their parent folder/sibling activities. They can be executed based on conditions.

Shortcuts

Shortcuts are links to folders. They allow sharing of configuration across folders and catalogs. Like regular folders, they can get parameters from their calling catalog item and can return results to their calling catalog item.

String Tables

String Tables represent data fragments that can be collected and retrieved based on an appropriate set of lookup keys. Such items are commonly used to provide textual messages and values in various languages such as Spanish, English and Chinese, varying only the lookup keys rather than application functionality or configuration.

Parameters

Parameters represent the input to a catalog item (folder, activity or shortcut). Parameters are not “global variables”. Folders which are executed directly from an application automatically have access to the command parameters passed from the application, but preferably all parameters used by child catalog items must be specified as parameters to the folder being executed directly from the application. Similarly, any data required by an activity must preferably be specified as parameters to the activity. Child folders or shortcuts must also have parameters specified. This relationship is analogous to the relationship between arguments and functions in a conventional (3GL) programming language.

Parameters can be added to any catalog item, and can be similarly viewed, edited or deleted as required. A list of parameter properties is enumerated in Table 1 below.

TABLE 1

| Name | Description of the purpose of the parameter |
|---|---|
| Source Item | Select Parent Folder/External Source to get the data from |
| | the calling application or parent folder for a sub-folder or |
| | activity, or select the sibling activity or folder the data |
| | comes from. |
| Source path | Select the name of the corresponding parameter (if coming |
| | from a parent folder) or result (from a sibling activity, |
| | folder or shortcut). If the data is coming from the calling |
| | program, type it's name rather than selecting from the list. |
| Target | Required for shortcuts only. Select the name of the |
| | corresponding parameter in the shortcut target. |
| Default | To use a constant value, enter no source item or path and |
| | enter a default. If a source item and path are selected, |
| | default will only be used if the caller did not specify the |
| | parameter value. |
| Data type | Choose Object (for a COM+ object), XML (for an XML |
| | string) or simple for a basic data type (for example, string, |
| | number, date, etc). |

Note:
Default does not over-ride a “blank” or null value—it will only be used if no value with the specified name is provided.

Results

Results represent the output from a catalog item (e.g. folder, activity, string-table or shortcut). Results can be added to any catalog item, and similarly viewed, edited and deleted as required. A list of result properties is enumerated in Table 2 below.

TABLE 2

| Name | Description of the purpose of the result |
|---|---|
| Source item | For activities, select Self to indicate that the data originates |
| | from the selected activity. For folders, select the name of |
| | the child item the data originates from. |
| Source path | For activities, type the data path (this is interpreted |
| | differently by different activities, and can be optional). For |
| | folders, select the result name for the item selected in |
| | source item. |
| Default | The default value will be used in the (unusual) event that |
| | the activity or folder does not return a value. This is mostly |
| | used during development/debugging. |
| Data type | Choose Object (for a COM+ object), XML (for an XML |
| | string) or simple for a basic data type (for example, string, |
| | number, date, etc). |

Conditions

Conditions are implemented as script code such as VBScript or Jscript, and allow catalog items to be executed depending on the result of that code. They are useful for ad-hoc changes to the application, during testing and give the developer flexibility when handling unusual situations (like error handling). Conditions can be added to any catalog item, and similarly viewed, edited and deleted as required. Language Select the Active Scripting language of your choice (for example, VBScript or Jscript, but can be any installed Active Scripting language).

Timeout Set the timeout time for your script (in seconds), or −1 for no timeout.

Condition script This is the script text. It must return a boolean value (true or false). In the script, you will have access to all of the parameters passed to the catalog item.

Validation

Validations can be placed on any catalog item, folder, activity, string-table and shortcut. Validations are tests or conditions that must hold true. If a validation rule is false, a run-time error occurs. Validation can be added to any catalog item, and viewed, edited and deleted as required. A list of validation properties is shown below;

| | |
|---|---|
| Error Number | User defined error number (Between 1-65535). |
| Description | Description of the purpose of the validation. |
| Language | Scripting language, VBScript or JavaScript. |
| Execution Sequence | When the validation should occur. That is, before or |
| | after the catalog item is run. |
| Rule | A validation expression that must evaluate to true or |
| | false. |
| Message | The error message that is displayed to the user. |

Error Handling

Error Handling allows catching and redirection of run-time errors and failed validations. A range of error numbers could be handled by a single entry. Error handling can be added to any catalog item, and viewed, edited and deleted as required. When error ranges are added to a catalog item, this indicates that the item is a “error handler” for the error ranges specified, and that any error that occur before the execution of the specified catalog item will be handled by the specified catalog item. A list of error properties is shown below:

| | |
|---|---|
| Range | Specify one or several error range(s). Error ranges can |
| | specified as nnn—nnn, nnn—nnn, where nnn is a error |
| | number. |
| Description | Description of the purpose of the error range. |

Security

Security can be applied to any catalog item or catalog. Integrated security implements a form of access control to restrict access as required. Prior to an operation upon a catalog item (for example, execute, read, update or delete) an access check is performed. The access check verifies that the process performing the operation has the correct permissions to do so.

Security is integrated with the operating system (Windows 2000 in the presently described embodiment). Using integrated security is much less vulnerable than using application-based security, and takes advantage of operating system user and group management applications.

Source code control

Any catalog or catalog item can be “checked in” to a source-code control environment, such as Microsoft Visual SourceSafe. Source-code control environments such as SourceSafe are widely used to manage project source code - allowing team members to work successfully together without overwriting each other's work, giving developers the safety of storing old revisions so they can try new techniques and roll back to an old revision if necessary, and allow developers to record revision history against their source code.

Catalog Import and Export

Catalogs and catalog items (and their child items) can be exported to an XML file that can be imported into another server. This allows for the deployment of a catalog to one or more “live” servers from the development environment. Import/Export can also be used as a backup mechanism.

Comparison Tool

The comparison tool compares two catalogs, or catalog export files, and reports the differences between them in a visual display. The comparison tool can be used determine the changes made to a catalog over a period of time. This allows system integrators for applications developed in the environment to apply custom changes, and still be able to apply standard upgrades and re-apply the custom changes much more easily.

Agent

The Agent gives developers an additional way to launch the Engine and run folders. The embodied agent is extensible, and ships with several pre-made “Event Monitors” to detect timed events, changes in directories and incoming data on a Microsoft Message Queue, but developers can also construct their own event monitors. Event monitors are added to the Agent configuration, with the following properties:

| | |
|---|---|
| Name | Descriptive name to |
| | identify your event monitor |
| Description | Longer description (for your reference) |
| Enabled | The enabled flag can be used to |
| | temporarily disable an event monitor. |
| ProgID or Object Class ID | The object class identifier (e.g. COM+ |
| | ProgID) of your event monitor component |
| | (must conform to IEventMonitor |
| | interface). |
| Polling Enabled | Some event monitors require polling to |
| | operate. Enable polling by checking this |
| | check box. |
| Polling Interval | Polling interval (in 500 ms increments). |
| Crash Protection Enabled | When a event monitor raises an error, the |
| | Agent will automatically shut down and |
| | restart the event monitor, if crash |
| | protection is enabled. |
| Crash Protection: Wait | Specifies how long to wait (in seconds) |
| | before restarting an event monitor. |
| Crash Protection: Retry count | Specifies how many times to restart an |
| | event monitor before giving up. |
| Run As | As with system services, the developer |
| | may want to run a Event Monitor “as” a |
| | user, because it may need to access |
| | resources that are only available to a |
| | specific user or group. If this is the case, |
| | then selection of the user and entry of the |
| | password is performed here. |
| | The Password is stored in the catalog as an |
| | DES encrypted string. |
| Parameters | Parameters are passed to the Event |
| | Monitor on start-up. These are specific to |
| | each Event Monitor implementation. For |
| | example, the Microsoft Message Queue |
| | listener requires a queue name as an |
| | initialization parameter. |
| Folder | Contains the name of the dXcribe folder |
| | you want to run. |
| Run As | Users may want to run a Folder “as” a |
| | user, because security may be set on the |
| | target folder, and the LocalSystem account |
| | that the service runs on cannot be assigned |
| | rights to a folder. |
| | The Password is stored in the catalog as an |
| | DES encrypted string. |
| Parameters | Parameters are passed to the Event |
| | Monitor on start-up. These are specific to |
| | each Event Monitor implementation. For |
| | example, the Microsoft Message Queue |
| | listener requires a queue name as an |
| | initialization parameter. |

IEventMonitor Interface

An implementation of the IEventMonitor interface can be used by the Agent engine to schedule folder execution based on incoming data, the system time or any other, criteria that a developer might require, as they can be custom written by developers.

IEventMonitor is an abstract interface that cannot be directly instantiated, but provides a common set of properties and methods that specific providers can implement. The interface defines the full set of functionality that an implemented class must cater for.

Methods and properties

Startup

Allows the implementation to initialise, (for example, to get handles to resources required)

Shutdown ()

Tells the Event Monitor to stop, and release any resources acquired.

Pause ()

Tells the Event Monitor to stop monitoring, release resources and go into an “idle” state.

Continue ()

Tells the Event Monitor to start monitoring (and re-acquire resources)

GetData

Allows the implementation to return data.

Poll ()

The Poll event can be raised at intervals specified in the service configuration.

Callback “Events”

Errors

Implementations can call this event to Log an error to the event log, and trigger a stop and restart of the Event Monitor. The “fatal” flag can be set to true to stop the service attempting to restart the Event Monitor (for example, in the case of an invalid configuration).

LogEvent

Implementations can call this event to log a message to the event log.

Execute ()

Implementations use this event to signal the service that the Event Monitor has detected it's target event, and the service should run the configured folder.

Command-line execution

The command-line utility is designed to enable the execution of a folder from a command-line or automated environment. It provides the ability to provide input parameters and receive results from a nominated folder.

Profiler

Profiler is a graphical tool that allows a developer to monitor and collect a range of events such as when an activity begins executing, when an activity finishes executing, when a folder begins executing, when a folder finishes executing, when an error occurs.

Various data is captured when events are monitored, including the types of event being traced, the username of the users performing an activity, the duration of each event and activity-specific data.

Event data can be filtered so that only a subset of the event data is collected. For instance, a filter can be defined to trace only those OnActivityExecuteComplete events with a duration greater than one second. Profiler can also be used to monitor the performance of the engine, to identify slow-executing folders or items or to capture run-time error information.

Analyser

The analzyer is a tool that facilitates debugging, testing and measuring the performance of Catalog items and activities.

The Analyzer executes catalog items using the Engine. The Engine passes data back to the Analyzer which includes parameter, result and performance data. Activities not within the dXcribe Catalog, can also be executed. This is helpful for debugging and testing individual activities.

The Analyzer also supports the saving and restoration of execution data. This can help reduce testing time by automatically re-executing a previously saved test.

Environment object reference

Now described is the environment object reference which contains information regarding the use of environment core components, including the environment core library (which contains the IActivity interface and container object, the configuration interface, the Web Application Services Platform and the engine/command objects), as described further below.

IActivity interface

An implementation of the IActivity interface 30 (refer FIG. 2) provides data from a data source—a database stored procedure, file, mail server or any other source of data, or performs processing and provides output preferably based on input. IActivity implementations should also return a status value.

IActivity is an abstract interface that cannot be directly instantiated, but provides a common set of properties and methods that specific providers can implement. The interface defines the full set of functionality that an implemented class must cater for.

Implementations of IActivity get input parameters from the run-time engine, perform some processing and can return output parameters (via the GetData function) along with a status flag.

The input parameters for the Execute method are; contained in a IContainerStatic Object 34, which can contain multiple data items. Implementations should always assume the possibility of multiple rows

IActivity implementations are passed an additional container object which contains dXcribe “environment variables”. Among these will be the Session.LCID (locale ID) and any other information that will be of use to most activities.

The method and property interface is defined by the following methods:

Initialize Method—allows the implementation to initialize itself (for example, establish a connection or initialize variables).

Execute Method—runs the activity.

Terminate Method—allows the implementation to un-initialize itself (i.e. drop connection, deconstruct internal variables).

GetData Method—allows the implementation to return data.

Refresh Method—called between each GetData call in order to ensure that the most current data is available.

Errors Property—Provides a mechanism for returning extended error information to the engine where necessary.

IActivityInfo interface

Implementations of the IActivity interface can optionally be complemented by the mutual support of the IActivityInfo interface, which is used to enable the customisation at run-time of the dXcribe Architect environment to suit the particular activity component. For example, an ActiveX Data Object IActivity component may also provide an IActivityInfo interface implementation that visually alters generic activity properties such as “InitializationInfo”to a more intuitive “Connection String” label.

Container object

The Container object 32 (refer FIG. 2) is used to store one or more data items. It is supported by the IContainerStatic interface, which can be used to create a read-only instance. In documentation, the IContainerStatic interface is referred to as the “read only” container.

The container object is essentially a more functional version of the Collection object (referred to in the Microsoft Windows SDK as IEnum Variant), and can be used in the same way. In addition to the regular collection methods and properties (Add, Remove, Count, Item, Enumeration), the container object also supports Keys, RemoveAll, Exists and type Checking.

The container is utilized by the WASP request object, IActivity interface and within the dXcribe engine, and can also be used by other applications and objects. The Container implements the IContainerStatic interface, so the same container object can be read-only or read-write, depending on the object reference it is bound to. In FIG. 2, the asterisk (*) indicates implementation of the object on which the asterisk is marked as a container or IContainerStatic object.

Environment engine object

The environment engine object is the main entry point to the environment core components for third party components. The environment engine class is intended as the entry point from external interface ‘emissaries’ like the Agent, Profiler, Analyzer, Command-line interface, WASP, and other (e.g. Win32) applications.

Configuration interface

The configuration interface accesses the selected catalog and uses an Item manager 36 (IItemManager abstract component interface) to perform reading and writing operations to a data sink. At present, implementations for XML files and SQL server databases are available, but these could be extended.

A read/write interface is achieved by the use of the container object. Because the container object can be bound to an IContainerStatic object reference, read-only container objects can also be returned. (A read-only container can be ‘converted’ to a writable one by setting it to a Container reference).

One of the design goals of dXcribe was to not require a database.

Each catalog entry specifies the ItemManager to use. For example, in the preferred embodiment this data is stored in the registry key

HKEY_LOCAL_MACHINE\SOFTWARE\dXcribeTechnologies\dXcribe Engine\Catalogs\

Each catalog has it's own subkey, with the following entries:

Description—Long ‘human readable’ name of catalog

InitializationInfo—Connection information (i.e. Filename of xml file or DSN of MS SQL server database).

Typename—COM+ ProgID of IItemManager implementation.

The unique ID and foreign key for configuration tables (or XML file) is a UUID (Universally Unique Identifier). This allows for uniqueness across deployed environments (which means an application can be ‘exported’ from one server and ‘imported’ to another, without re-generating the unique ID's and without key violations. This also allows for easy deployment of upgrades that involve configuration database changes.

The Microsoft SQL Server implementation of IItemManager uses the XMLData field to store extended information in the same XML “fragment” format as the XML file. It is this field that differentiates the various catalog item types.

Environment prepackaged components

The environment is preferably supplied with a set of “prepackaged” components, which are IActivity implementations that perform many of the common tasks required by many intended applications. Such common tasks may include database access, internet functionality, file system access and more.

Example of environment configuration

At run time, applications point to a specific folder, and the environment will “run” that folder. The engine interprets different catalog item types in different ways.

| Catalog item Type | Interpretation |
|---|---|
| Folder | Run all activities in the folder. The engine allows |
| | for recursive executions. |
| Activity | Run the component (for example, COM+ program) |
| | associated with the activity. |

The engine has been created with a broad view as to the type of applications being developed for it in mind (for example, Web-based applications, standard Win32-based applications, and applications based on emerging platforms such as Windows CE, WAP, Web enabled consumer devices).

IEngineExtension interface

The IEngineExtension abstract interface enables the construction of additional functionality in the core of the dXcribe engine by third parties without the need for recompiliation of the engine itself. One such example of the use of this interface in the present embodiment lies in the infrastructure components used to produce the profiling information for the Profiler utility. Rather than including this code in the body of the engine core, an IEngineExtension was constructed to produce profiling information for the Profiler utility.

Web-based applications

Web based applications can use a single ASP script to configure settings in the Web Application Services Platform (WASP) 40 (refer FIG. 1) for their application. The catalog and root folder are set in the ASP page, and individual XSL stylesheets or static HTML pages point to the catalog item to execute. HTML POST and GET data (including uploaded files) is collected from Microsoft Internet Information Server and can be passed to the engine, and engine components provide output in the form of a HTML string passed to the ASP response object.

Win32-based applications

Win32 or similarly-based applications can directly instantiate the Engine object and provide it with parameters, execute the desired catalog item and utilize the command results.

Configuration interface

The interface is the main configuration tool for developers and administrators. Using the interface, users can create and maintain catalogs and their component parts.

WASP

The Web Application Services Platform, or WASP provides a means by which any [COM or COM+] capable web server (Microsoft Internet Information Server) can leverage the dXcribe engine's functionality. The WASP serves as the conduit between the web browser requests (channelled through the web server) of an end user 42 and the engine objects 2; it automates and standardises the way in which web-based applications are built with dXcribe.

The end user may interact with the WASP via a web-based enterprise application 38, or may interact with the engine via a non-web-based enterprise software application 39.

The WASP objects will interact with the engine to perform business logic, data read/write and provide UI responses (that is, run catalog items based on the value of the tag). Business logic will be performed by implementation of the IActivity interface in the normal manner in which the engine environment operates. This method removes one layer of software development for developers (the development of web-specific program code), replacing it with a combination of the WASP and implementations of the IActivity interface.

The WASP receives the name and path of a module to call within the defined dXcribe catalog configuration (in the URL query string or form variables). The WASP needs to query the Engine Configuration objects to determine what parameters to populate in the command object, based on the catalog item being run. Properties of the WASP.WebHandler object are explained below:

| Name | Description |
|---|---|
| AbsolutePath | Fully qualified path to catalog item in the form |
| | dXcribe://catalogname/fullpath. The dXcribe namespace |
| | qualifier is optional. If this form is used, the |
| | CatalogName, ParentFolder and ItemName properties are |
| | automatically populated. |
| CatalogName | Catalog name to use |
| ParentFolder | Path to catalog item, not including the catalog item to run |
| ItemName | Catalog item to run |

The WASP Execute method is the only valid entry point for the WASP. The process method converts the contents of the web request object to binary form so that it can support file uploads. The request object passed to the engine is an emulation of the web server's request object. If the user specifies AbsolutePath, no other action is necessary. Alternatively, specify Catalogname, ParentFolder and Itemname.

Itemname is generally overridden by the DXI GET variable, if it is set. To set the DXI variable, add it to your form action attribute. For example, <FORM ACTION=“wasp.asp?DXI=MyFormItem”>.

Usage Scenario

When developing software applications using the environment, the developer 44 performs a number of key tasks. These tasks are generally the same regardless of whether the user is creating a new application or applying changes to an existing one, and are:

Determining the target platform(s) to which the application will be delivered—usually either or both of web and Win-32

Designing and implementing an appropriate folder structure within which to store the configuration information using the environment architect. Particular consideration should be given to areas of common functionality that can be stored in a folder such that a shortcut catalog item can be used to leverage this functionality. This approach takes full advantage of the folder/item metaphor of the invention.

Identifying which of the provided and/or pre-written IActivity software components will be used within each folder, and in which sequence.

Developing additional software components that implement the nominated IActivity interface—this can be done using Visual Basic or one of a number of capable software development languages.

Placing commonly used scenarios (i.e. groups of activities) into appropriate folder structures in order to make them available to multiple other scenarios via the shortcut mechanism.

Configuring each catalog item (for example, activity, shortcut) into an appropriate sequence and folder within the environment using the dXcribe Architect in the tool suite 46. This configuration process requires the nomination via the property page dialogs of a number of properties that are stored in the dXcribe configuration, some of which may include: Object Class ID (e.g. COM+ Prog ID), Command Text, Initialization Data, Parameters, Results, Execution Conditions, Validation Rules, and Error Handler information.

Assigning the appropriate security settings to each folder and/or activity using the environment architect.

If using a web-based application, installing and configuring the WASP on a web server, such as Microsoft Internet Information Server 5.0 provided in Windows 2000.

If developing a Win-32 application, writing interface application code to interact with the engine and command objects so as to deliver the application's user interface component functionality via the environment.

Developing any additional database or other program code using appropriate tools for which either the provided or custom IActivity implementations 48 provide the connectivity between the dXcribe engine and the program code of the enterprise systems 50. A good example of this might be stored procedures and table structures on an SQL Server, access to which is provided by the ADOProvider IActivity shipped with the engine.

Testing the application in accordance with prevailing testing procedures and practices.

Deploying the application in a production system, giving due consideration to performance, clustering and security as appropriate. It should be noted that the various components of the system (e.g. Engine, Command, ActivityManager, and Activity Objects) can be deployed onto different platforms using remote component functionality in order to aid scalability; this only affects deployment and does not place any restrictions on or require any alterations to program code.

Overview

There has been described an environment for application development which allows developers to expediently develop applications with reference to organising components in an hierarchy using a folder/item metaphor. The advantage of such an approach is that the structure of the software application is visualised in a familiar and easily manipulated manner, and enables a greater amount of software re-use than previous approaches. This increased re-use of software componentry has benefits in terms of time to model and develop software applications as well as in their ongoing maintenance, since a smaller code-base with a high degree of re-use is less expensive in terms of time and cost to maintain.

The approach described affords the visual representation of abstract software development concepts using a familiar folder/item paradigm, as well as removing the necessity of custom-building application infrastructure and implementing recommended design patterns and techniques, since embodiments of the invention implement these concepts.

Finally, it can be seen that the folder/item metaphor helps developers to become familiar with the development environment easily, and enables less-experienced software developers to quickly produce software that would normally require more skilled developer resources. In addition, skilled or relatively unskilled developers can re-use the supplied or custom developed software components to perform a wide variety of trivial and complex development tasks. Such tasks can range from database access and file system operations through to integration with custom hardware devices and the sending of SMS messages. The tasks can be performed whilst focussing attention on satisfying the business rather than technical requirements of a project.

Accordingly, the invention provides a new technical effect in the organisation and execution of software components.

It will be understood that the invention disclosed and defined in this specification extends to all alternative combinations of two or more of the individual features mentioned or evident from the text or drawings. All of these different combinations constitute various alternative aspects of the invention.

1. A software application development environment having a hierarical structure visually represented as a folder/item metaphor for organisation of a plurality of software component items to be executed in the environment, each component item including one or more associated features and the component items being visually grouped using the folder/item metaphor to allow features of one component item to apply to other component items in the environment.

2. An environment as claimed in claim 1 wherein the environment is also a run-time environment.

3. An environment as claimed in claim 1 or claim 2 which allows simultaneous or sequential execution of the component items.

4. An environment as claimed in claim 1 wherein:
a grouping of the component item is represented as a folder;
an application component is represented as a component item; or
a reference to an application component is represented as a shortcut to a component item or an alias for a component item.

5. A method of providing a software application development environment, the method including the steps of providing a hierarchical structure visually represented as a folder/item metaphor for organisation of a plurality of software component items to be executed in the environment, providing each component item with one or more associated features and visually grouping the component items using the folder/item metaphor to allow features of one component item to apply to other component items in the environment.

6. A graphical user interface for software application development, the interface providing a hierarchical structure visually represented as a folder/item metaphor for organisation of a plurality of software component items to be executed in the environment, each component item including one or more associated features and the component items being visually grouped using to folder/item metaphor to allow features of one component item to apply to other component items in the environment.

7. A computer or computer network having a sole development environment as claimed in claim 1.
